(19) United States
(12) Patent Application Publication
(10) Pub. No.: US 2009/0276409 A1
(43) Pub. Date: Nov. 5, 2009

(54) Shareable Information System

(75) Inventor: Patrick O. Young, Allen, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/112,868

(22) Filed: Apr. 30, 2008

(51) Int. Cl. G06F 7/06; G06F 17/30

(52) U.S. Cl. 707/4; 707/103 Y; 707/102; 707/E17.014; 707/E17.055

(57) ABSTRACT

According to one embodiment, a shareable information system includes a number of organizations having a database communicating with one another through a network. Each database stores data objects with a structured metatag. Each structured metatag uniquely identifies its respective data object and has fields structured according to a common architecture. A request broker of one particular organization may resolve a desired data object from among the plurality of data objects according to the specified structure and retrieve the desired data object from the database of another organization.

### TECHNICAL FIELD OF THE DISCLOSURE

This disclosure generally relates to information systems, and more particularly, to a shareable information system and a method of generating and maintaining the same.

### BACKGROUND OF THE DISCLOSURE

Organizations manage databases containing information that may be useful to other organizations. For example, military organizations, such as the army, navy, and air force may share information in a collaborative effort to achieve a common goal. Vendors providing equipment and supplies to these organizations may also benefit by sharing useful information stored in their own databases. To promote information sharing among its member organizations, the United States Department of Defense (DoD) has developed a process for handling information referred to as the global information grid (GIG). The global information grid defines a set of information handling capabilities, associated processes, and personnel for managing information among its various military agencies.

### SUMMARY OF THE DISCLOSURE

According to one embodiment, a shareable information system includes a number of organizations having a database communicating with one another through a network. Each database stores data objects with a structured metatag. Each structured metatag uniquely identifies its respective data object and has fields structured according to a common architecture. A request broker of one particular organization may resolve a desired data object from among the plurality of data objects according to the specified structure and retrieve the desired data object from the database of another organization.

Some embodiments of the disclosure may provide numerous technical advantages. For example, access may be provided to information stored in databases having structures that differ from one another. Organizations may uniquely tailor the structure of databases they manage. Access to an organization's database may be provided by one or more tools that may be referred to as a request broker. This request broker, however, may be ill-suited for access of information from databases managed by other organizations. Data objects implemented with structured metatags according to the teachings of the present disclosure may provide benefit in that request brokers may search meaningful content in other databases using structured metatags in a relatively efficient manner.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a block diagram showing one embodiment of a shareable information system according to the teachings of the present disclosure;

FIG. 2 shows one embodiment of a structured metatag that may be used with the shareable information system of FIG. 1;

FIG. 3 is a table showing several tracking parameters that may be implemented with the structured metatag of FIG. 2;

FIG. 4 is one example of several tracking parameters that may be combined into coded data for use with the structured metatag of FIG. 2;

FIG. 5 is a diagram showing a metatag structure that may be used to manage the structured metatag of FIG. 2; and

FIG. 6 is a flowchart showing a series of actions that may be performed by the shareable information system of FIG. 1.

### DETAILED DESCRIPTION OF EXAMPLE EMBODIMENTS

The United States Department of Defense (DoD) has established the global information grid (GIG) to promote information sharing among its member agencies. One particular aspect addressed by the United States Department of Defense has been the use and management of technical manuals. The MIL-D-87269 specification defines a data format for technical manuals stored in electronic form referred to as interactive electronic technical manuals (IETMs). According to this specification, interactive electronic technical manuals may be classified according to one of five classes in which class 5 interactive electronic technical manuals are the most advanced. Interactive electronic technical manuals have successfully reduced management overhead associated with technical documentation that have traditionally been stored on paper.

Military agencies, such as the army, navy, and air force, along with their associated vendors, may benefit by sharing information stored in interactive electronic technical manuals. Sharing information among these various organizations, however, may not be easily accomplished. For example, databases are typically organized according to a unique structure suitable for use by their respective organizations. Each organization may implement and manage a request broker that is ideally suited to retrieve and manipulate information stored in its own database. A request broker generally refers to an executable program that brokers requests from clients to information stored in databases, such as interactive electronic technical manuals. Because the needs of organizations often differs significantly, request brokers used by one organization to access and manipulate information stored in its own database may be ill-suited for accessing information in others.

In an attempt to alleviate this problem, the United States Department of Defense has issued Military Handbook 511 (MIL-HDBK-511) in May 2000. MIL-HDBK-511 defines a common user interface that may be used to access interactive electronic technical manuals that may be stored in differing formats. The MIL-HDBK-511, however, does not address interoperability among differing interactive electronic technical manual formats.

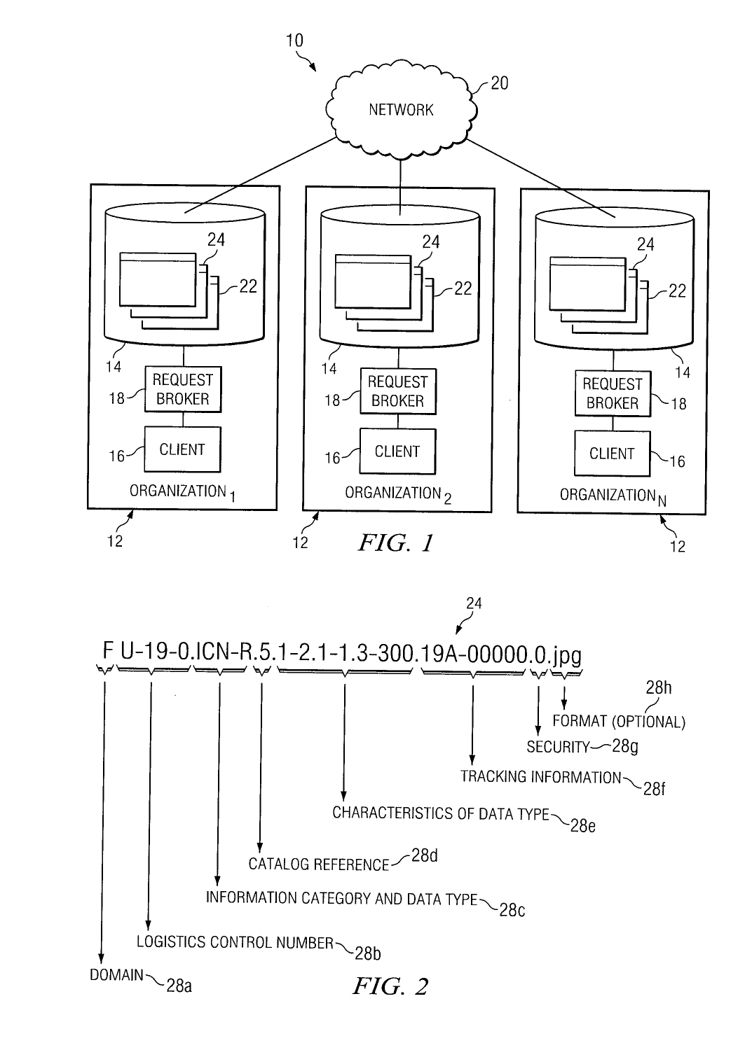

FIG. 1 shows one embodiment of a Shareable information system 10 that may provide a solution to this problem as well as other problems. Shareable information system 10 includes a number of organizations 12 that each have a database 14 for the storage of information. Each database 14 is accessible by a client 16 using a request broker 18. Databases 14 are coupled together through a network 20 to provide access by clients 16 of other organizations 12. Databases 14 have multiple data objects 22 for storage of information according to commonly accepted database design principles.

Each data object 22 may be uniquely organized in its respective database 14 according to each organization's needs. As such, each database 14 may incorporate a format that differs from one another. According to the teachings of the present disclosure, each data object 22 may include a structured metatag 24 that provides for access by request brokers 18 of other organizations 12. Each structured metatag 24 may include coded data associated with information stored inside. Organizations 12 may collaborate with one another to determine a common metatag structure that describes a format of the coded data. Using coded data, request brokers 18 may gain access to data objects 22 stored in databases 14 of other organizations 12. In one embodiment, data objects 22 may be formatted as extensible markup language (XML) objects. In another embodiment, each data object 22 incorporate an XML linking language (XLINK) in which data objects 22 formatted as XML objects may be configured to reference other data objects 22 stored in its database 14 as well as data objects 22 stored in other databases 14.

Organizations 12 may comprise any type and number of entities wishing to share with others, information stored in their respective databases 14. In one embodiment, organizations 12 may include various military agencies, such as the army, navy, and/or air force. Organizations 12 may also include supporting organizations 12, such as vendors that supply products and services to these military agencies. Organizations 12 such as these may share information over a network 20, which in one embodiment is a network known as a global information grid (GIG). The global information grid comprises a project managed by the United States Department of Defense (DoD) that provides a framework for information sharing among its member organizations.

Databases 14 managed by their respective organizations 12 may include any suitable structured repositories of information. In one embodiment, databases 14 may include interactive electronic technical manuals structured according to Military Document 87269 (MIL-D-87269). These interactive electronic technical manuals may include any class of interactive electronic technical manual (IETM) functionality as specified in military handbook 511 (MIL-HDBK-511). In a particular database 14 comprising a class 4 interactive electronic technical manual, data objects 22 are stored in a relational format and referenced using relational object identities (R-OIDs). These relational object identities, however, may not provide sufficient information for access by request brokers 18 of other organizations 12. This may be due, at least in part, to the manner in which relational objects are organized within their respective databases 14. Certain embodiments incorporating structured metatags 24 may provide access to information in databases 14 by request brokers 18 of other organizations 12. Thus, request brokers 18 may determine aspects of particular data objects 22 by analyzing coded data stored in their respective structured metatags 24.

Structured metatag 24 may include any portion of its respective data object 22. In one embodiment, structured metatag 24 includes the filename of its respective data object 22. In other embodiments, structured metatag 24 may include one or more fields of its respective data object 22. Data objects 22 such as these may be implemented in relational form such that structured metatags 24 may be stored in independently accessible tables for access by request brokers 18 of other organizations 12.

Client 16 may include any suitable executable program executed on a computing system that communicates with its associated request broker 18 or request brokers 18 of other organizations 12. In one embodiment, client 16 communicates with request brokers 18 using a client/server type protocol. For example, client 16 may include a suitable graphical user interface (GUI) providing a particular view of data objects 22 that are tailored to the needs and/or desires of its respective organization 12. As another example, client 16 may be a web browser, such as a Firefox, Internet Explorer, or Opera web browser.

Request broker 18 may include any suitable type and number of tools for accessing data objects 22 from databases 14. Each request broker 18 may include executable software that is executed on one or more computing systems. For example, a particular request broker 18 may incorporate middleware, such as Java Platform, Enterprise Edition (Java EE) middleware, that provides access of database 14 to multiple clients 16 within a particular organization 12. Computing systems on which request broker 18 is executed may include one or more input/output ports for communicating with databases 14 and their associated clients 16.

Request broker 18 provide message translation and other tasks for retrieving and editing data objects 22 by client 16. Each request broker 18 may communicate with database 14 of its organization 12 and databases 14 of other organizations 12 using a structured query language (SQL) sequence of commands. Structured Query Language is a standard interactive programming language from retrieving and editing information from databases.

FIG. 2 shows one embodiment of structured metatag 24 that may be used with shareable information system 10. In this embodiment, structured metatag 24 includes a number of fields 28a through 28h describing one or more aspects of information stored in its respective data object 22. Fields 28a through 28h of structured metatag 24 conform to a specified metatag structure that will be described in detail below. Fields 28a through 28h may include a domain field 28a, a logistics control number field 28b, a information category and data type field 28c, a catalog reference field 28d, a data type characteristic field 28e, a tracking information field 28f, a security field 28g, and a format field 28h. The fields 28a through 28h shown may include coded data describing one or more aspects pertinent to data objects 22 of an interactive electronic technical manual. In other embodiments, structured metatag 24 may include any suitable type and number of fields 28a through 28h describing various aspects of information stored in data object 22.

Domain field 28a may include coded data describing the domain in which data object 22 exists. For example, domain field 28a may store information referring to the organization that owns and manages data object 22. Logistics control number field 28b may include coded data describing various platforms or sectors of the domain. Information category and data type field 28c may include coded data associated with a particular genre of information stored in data object 22. That is, coded data in information category and data type field 28c may describe a number of data objects 22 conforming to a particular category. In one embodiment, data objects 22 within this category may be owned by platform described by logistics control number field 28b, yet be used by other platforms of the domain. Catalog reference field 28d may include coded data describing version information associated with information category and data type field 28c and/or logistics control number field 28b.

Data type characteristic field 28e, track information field 28f, security field 28g, and format field 28h may provide relatively specific information about information contained in its respective data object 22. Data type characteristic field 28e may include coded data describing one or more characteristics of information stored in data object 22. Coded data stored in data type characteristic field 28e may describe aspects of a particular product, document, or service procedure managed by the owner of data object 22. In a particular embodiment in which data object 22 comprises a portion of an interactive electronic technical manual, coded data in data type characteristic field 28e may describe a certain maintenance procedure for a product, such as a piece of military armament. Security field 28g may include coded data describing a particular security level attributed to information stored in data object 22. Format field 28h is optional and may include a file extension describing a file type that may be used by a typical file system.

Track information field 28f may include coded data that describes tracking information associated with data object 22. In one embodiment, tracking information may include where the information stored in data object 22 originated. In another embodiment, tracking information may include what the information type is based upon known task codes from various specifications, such as the military standard 1388 (MIL-STD-1388) that provide this type of tracking information. In another embodiment, tracking information may include where the information type is used and how it is used. Knowledge of these aspects of information stored in data object 22 may provide certain levels of background information useful for interpreting information stored in data object 22.

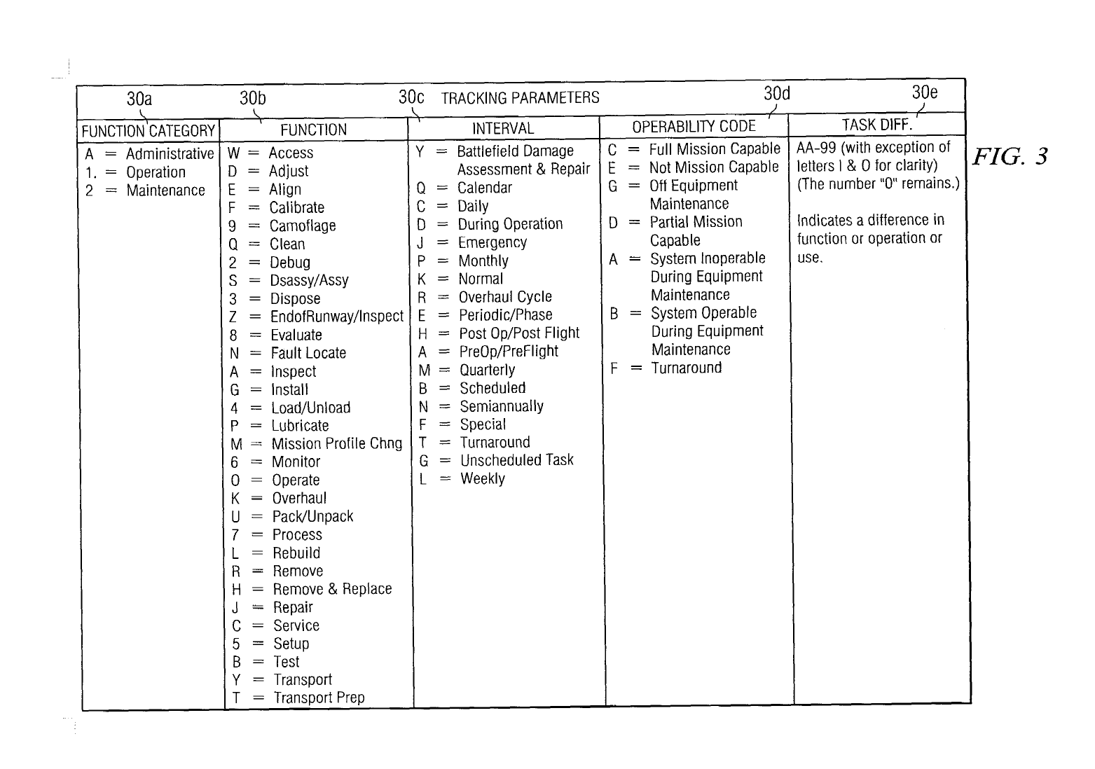

FIG. 3 is a table showing one embodiment of several tracking parameters 30 that may be stored in track information field 28f, or an analogous track information field in other embodiments of structured metatag 24. Tracking parameters 30 may include a function category parameter 30a, function parameter 30b, an interval parameter 30c, an operability code parameter 30d, and a task difference parameter 30e. Tracking parameters 30 may provide information regarding where information stored in data object 22 originated, what the information type is, and/or where the information type is used and how it may be used. In one embodiment, tracking parameters 30 may correspond to tracking parameters 30 specified in defense standard 60 (DEFSTAN 60) and/or government electronics and information association 007 (GEIA007). Coded data may be associated with each tracking parameter 30. Coded data may comprise an alpha-numeric symbol indicating a particular characteristic of its associated tracking parameter 30.

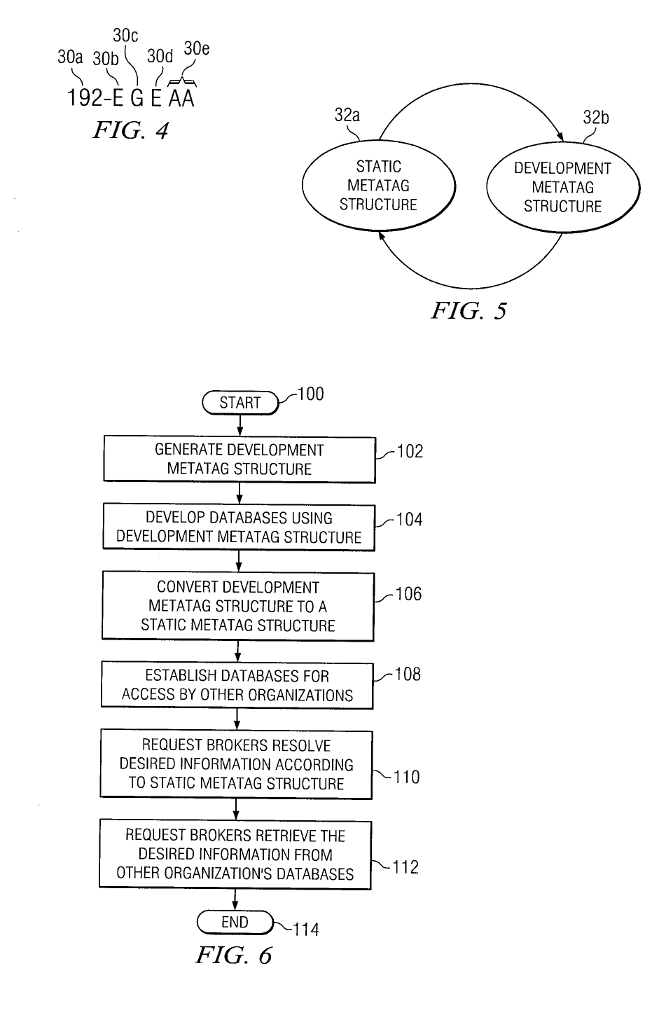

FIG. 4 shows one example of a particular tracking information field 28f that may be implemented with tracking parameters 30 according to the table of FIG. 3. In this particular example, coded data “19” indicates the system described by data object 22. Tracking information field 28f is populated with coded data “2” indicating that its respective data object 22 refers to a maintenance function. Function parameter 30b is populated with coded data “E” indicating that the data object 22 refers to an alignment procedure. Interval parameter 30c is populated with coded data “G” indicating that data object 22 refers to an unscheduled procedure. Operability code parameter 30d is populated with coded data “E” indicating that the system referred to by data object 22 is not mission capable. Task difference parameter 30e is populated with coded data “AA” indicating that data object 22 refers to the main task of the procedure.

The various tracking parameters 30 may provide tracking information of a data object 24 with which it is associated. Certain embodiments may provide background information that provides use of information in data objects 22 by request brokers 18 of other organizations 12. Tracking information may describe a perspective in which information in data object 22 was originated and/or maintained. Knowledge of this perspective may provide users within other organizations 12 proper insight to meaningful interpretation of information stored in data objects 22.

FIG. 5 shows a metatag development process according to the teachings of the present disclosure. Metatag development process generally includes a static metatag structure 32a and a development metatag structure 32b. Static metatag structure 32a and development metatag structure 32b generally refer to the rules, organization, and structure of how information may be stored in structured metatags 24. Static metatag structure 32a and development metatag structure 32b may specify the type of fields 28a through 28h and coding formats used to populate these fields 28a through 28h. Using the metatag development process, member organizations 12 may collaborate with one another to determine periodic modifications to the metatag structure that may affect the type and structure of structured metatags 24.

Static metatag structure 32a may include a particular structure that may be used for development of data objects 22 by developers of databases 14 in each organization 12. The static nature of databases 14 conforming to static metatag structure 32a may provide access of information by request brokers 18 from databases 14 of other organizations in a relatively stable manner. In a particular example in which databases 14 store electronic technical manuals, developers may generate new data objects 22 or modify existing data objects 22 according to static metatag structure 32a. In this manner, data objects 22 in each database 14 may have a specified structure that is commonly known and thus accessible by request brokers 18 of each organization 12.

Development metatag structure 32b may be implemented to incorporate periodic modifications to static metatag structure 32a. Development metatag structure 32b may be generated from an existing static metatag structure 32a or may be newly created. Static metatag structure 32b may be periodically modified due to numerous reasons, including recent changes in underlying technology, enhancements to the metatag structure, and/or modifications to the relational structure of data objects 22 within their respective databases 14. Development metatag structure 32b may be used during development of new databases 14 to enhance the specified structure of structured metatags 24 on an as needed basis. On a periodic basis, development metatag structure 32b may be converted into another static metatag structure 32a. This cyclical process may continue during the collaboration of member organizations 12.

Modifications, additions, or omissions may be made to shareable information system 10 without departing from the scope of the disclosure. The components of shareable information system 10 may be integrated or separated. For example, each organization 12 is shown having one database 14 that is shareable over a network 20. In other embodiments, a particular organization 12 may own and manage multiple databases 14 in which their respective request brokers 18 may access information from one another as well as from databases of other organizations 12. Moreover, the operations of shareable information system 10 may be performed by more, fewer, or other components. For example, other organizations that do not own or manage their own database may be configured to access information from databases 14 configured in shareable information system 10. As used in this document, “each” refers to each member of a set or each member of a subset of a set.

FIG. 6 shows one embodiment of a series of actions that may be performed to implement shareable information system 10. In act 100, the process is initiated.

In act 102, a development metatag structure 32b is created. The development metatag structure 32b may be generated or copied from an existing static metatag structure 32a. In one embodiment, portions of the development metatag structure 32b may have read and write access while other portion of the development metatag structure 32b may have read-only access.

In act 104, organizations 12 develop their databases 14 using development metatag structure 32. During development, organizations 12 may modify portions of development metatag structure 32. The specified structure of structured metatags 24 may be periodically modified to accommodate changes the overall structure of information stored in data objects 22. In this manner, organizations 12 may collaborate with one another to develop a metatag structure 32 that provides for sharing of information with one another.

In act 106, development metatag structure 32b may be converted to a static metatag structure 32a. In a particular embodiment in which development metatag structure 32b was copied from an existing static metatag structure 32a, a new static metatag structure 32a may be created.

In act 108, each organization 12 establishes its database 14 for access by other organizations 12 using static metatag structure 32a. Multiple organizations 12 may coordinate establishment of their databases 14 such that information may be made available over the network with a relatively high degree of reliability. In one embodiment, organizations 12 may select portions of their database 14 that is not to be made available to other organizations 12 and other portions that provide access according to security field 28g.

In act 110, request broker 18 of one particular organization 12 resolves desired information according to static metatag structure 32a established with regard to acts 102 through 108. Structured metatags 24 conforming to static metatag structure 32a may provide information that provides access by request brokers 18 of other organizations 12. In one embodiment, structured metatags 24 may include tracking parameters 30 that are established and agreed upon by member organizations 12. Tracking parameters 30 provide information, such as where information stored in data object 22 originated, what the information type is, and/or where the information type is used and how it may be used. This information may scanned by request brokers 18 in a relatively efficient manner to determine data objects 22 having information of interest.

In act 112, request broker 18 retrieves the desired information from a database 14 of another organization 12 resolved in act 110. For example, request broker 18 may determine location of desired information by searching databases 14 of other organizations according to specific coded data rules included in static metatag structure 32a. Thus, each member organization 12 may share information with one another according to an agreed upon standard of information structure.

The previously described process may be performed once or repeated each time modifications to the static metatag structure 32a is desired. In one embodiment, the process may be repeated on a periodic basis to provide updates to static metatag structure 32a in response to changing needs in the various organizations 12. In act 114, the process ends.

Modifications, additions, or omissions may be made to the previously described method without departing from the scope of the disclosure. The method may include more, fewer, or other acts. For example, interoperability checks may be performed throughout the previously described process to determine any changes to metatag structure 32 that may adversely affect access to databases 14 by request brokers 18 of other organizations 12. Data consistency checks may also be performed to ensure consistency and reliability of information stored in data objects 22.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A shareable information system comprising:
a plurality of electronic technical manuals storing information in a plurality of data objects, each data object comprising:
a portion of the information; and
a structured metatag having a plurality of fields that are arranged according to a specified structure, the plurality of fields storing coded data describing the portion of the information, the structured metatag uniquely identifying the each data object from other ones of the plurality of data objects stored in each of the plurality of independently managed databases; and
a request broker in communication with each of the plurality of electronic technical manuals and operable to:
identify a desired data object from among the plurality of data objects stored in each of the plurality of independently managed databases according to the specified structure; and
retrieve the desired data object from the electronic technical manual.

2. A shareable information system comprising:
a plurality of independently managed databases in communication with each other through a network, each of the plurality of independently managed databases storing information in a plurality of data objects, each data object comprising:
a portion of the information; and
a structured metatag having a plurality of fields that are arranged according to a specified structure, the plurality of fields storing coded data describing the portion of the information, the structured metatag uniquely identifying the each data object from other ones of the plurality of data objects stored in each of the plurality of independently managed databases; and
a request broker in communication with each of the plurality of independently managed databases and operable to:
identify a desired data object from among the plurality of data objects stored in each of the plurality of independently managed databases according to the specified structure; and
retrieve the desired data object from the independently managed database.

3. The shareable information system of claim 2, wherein the plurality of independently managed databases comprises a plurality of electronic technical manuals.

4. The shareable information system of claim 3, wherein the plurality electronic technical manuals comprises a plurality of class 4 electronic technical manuals.

5. The shareable information system of claim 2, wherein at least one of the plurality of fields comprises a tracking parameter indicating where the portion of the information originated.

6. The shareable information system of claim 2, wherein at least one of the plurality of fields comprises a tracking parameter indicating a data type of the portion of the information.

7. The shareable information system of claim 2, wherein at least one of the plurality of fields comprises a tracking parameter indicating a how the portion of the information is used.

8. The shareable information system of claim 2, wherein the plurality of data objects comprise a plurality of extensible markup language (XML) objects, the structured metatag forming a reference that is identified according to a XML linking language (XLINK) hypertext link.

9. The shareable information system of claim 2, wherein the structured metatag is human readable.

10. The shareable information system of claim 2, wherein the structured metatag comprises a filename of the data object.

11. The shareable information system of claim 2, wherein the structured metatag comprises one or more fields of the data object.

12. The shareable information system of claim 2, wherein the network comprises a global information grid.

13. A method comprising:
identifying, according to a specified structure, a desired data object from among a plurality of data objects stored in each of a plurality of independently managed databases that store information, the plurality of independently managed databases communicating with each other through a network, each data object comprising:
a portion of the information; and
a structured metatag having a plurality of fields that are arranged according to the specified structure, the plurality of fields storing coded data describing the portion of the information, the structured metatag uniquely identifying the each data object from other ones of the plurality of data objects stored in each of the plurality of independently managed databases; and
retrieving the desired data object from the one independently managed database.

14. The method of claim 13, further comprising generating a development structure, modifying the development structure, developing the plurality of data objects in each of the plurality of independently managed databases according to the development structure, and converting the development structure to another specified structure.

15. The method of claim 14, wherein generating the development structure further comprises generating an original development structure.

16. The method of claim 14, wherein generating the development structure further comprises generating the development structure from the specified structure.

17. The method of claim 13, wherein identifying the desired data object further comprises identifying the desired data object using the structured metatag comprising a tracking parameter indicating where the portion of the information originated.

18. The method of claim 13, wherein identifying the desired data object further comprises identifying the desired data object using the structured metatag comprising a tracking parameter indicating a data type of the portion of the information.

19. The method of claim 13, wherein identifying the desired data object further comprises identifying the desired data object using the structured metatag comprising a tracking parameter indicating how the portion of the information is used.

20. The method of claim 13, wherein identifying the data object from among a plurality of independently managed databases further comprises identifying the data object from among a plurality of electronic technical manuals.
